(19) United States
(12) Patent Application Publication
(10) Pub. No.: US 2006/0076771 A1
(43) Pub. Date: Apr. 13, 2006

(54) Printable dividers with folding tabs

(76) Inventor: Julie A. Schafer, Fairlawn, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/961,978

(22) Filed: Oct. 9, 2004

(51) Int. Cl. B42F 21/00

(52) U.S. Cl. 283/36

(57) ABSTRACT

A printable divider is formed from a stock sheet having a binder edge and a plurality of free edges. A folding tab is formed within the stock sheet proximate one of the plurality of free edges, and folds along a fold line from a first position, wherein the folding tab lies within the boundaries of the stock sheet as defined by the binder edge and plurality of free edges, to a tab position, wherein a portion of the folding tab extends beyond the boundaries of the stock sheet. In a particular embodiment, with the folding tab in the first position, the boundaries of the stock sheet are such that the stock sheet may be fed through a standard printing apparatus of the type that prints upon stock sheets having substantially straight edges.

### TECHNICAL FIELD

This invention generally relates to tabbed dividers for three-ring notebooks and the like. In a particular embodiment, the divider is formed of a stock sheet that may be printed upon using standard printing technologies, although in other embodiments, the divider need not be printable. At least one tab initially resides within the borders of the stock sheet, but may be folded to extend beyond those borders, providing an external, indicia-bearing tab.

### BACKGROUND OF THE INVENTION

Notebook dividers are well known for dividing materials within a notebook into logical, useful groups. Dividers generally consist of a sheet of material adequately sized for the notebook or similar article in which they are to be employed, and in order that they may be readily located, include tabs that extend beyond the primary borders of the sheet. The tabs usually bear indicia that helps to identify the material retained within the notebook behind a particular divider. Dividers provided with built-in tabs extending beyond their primary borders generally provide either blank tabs that are either preprinted or hand written upon or provide the tab in the form of a sleeve that receives a thin strip of paper that is hand written upon. The prior art also provides tabs that receive stickers that may be preprinted with indicia. Because the tabs stick out beyond the primary boundaries of the divider sheet, the divider sheets cannot be readily fed through a standard printer, photocopier or other printing apparatus generally suited for handling stock sheets having straight edge borders. Thus, a need exists in the art for a divider that can be printed upon using standard printing apparatus.

Notebook dividers of the prior art are typically provided in packages of multiple divider sheets, and, within these packages, a first group of divider sheets may have a tab extending beyond the primary boundaries of the divider sheet at a first position, a second group may have tabs extending at a second position, and so on, such that, in a single notebook, multiple sheets may be employed without placing the divider sheet tabs in alignment with one another, which would make them difficult to view and read. Such packages are useful, but require the creation of divider sheets in a plurality of forms. Additionally, when prior art divider sheets are placed into notebooks, they necessarily always serve to identify the group of materials that they divide from the rest of the notebook. That is, there is no means by which a divider may remain in a notebook and yet not provide a tab extending beyond the primary borders of the notebook pages. When a notebook contains a large number of dividers identifying a multitude of different subjects, it may be difficult to locate the subject matter of particular relevance to a given topic, as the multitude of tabs extending beyond the notebook pages begin to serve to confuse rather than to organize. Thus, there exists a need in the art for a divider having selectable tab placements, which the divider can also be manipulated to provide no tab at all.

### SUMMARY OF THE INVENTION

In one embodiment, this invention provides a printable divider formed from a stock sheet having a binder edge and a plurality of free edges. A folding tab is formed within the stock sheet proximate one of the plurality of free edges, and folds along a fold line from a first position, wherein the folding tab lies within the boundaries of the stock sheet as defined by the binder edge and plurality of free edges, to a tab position, wherein a portion of the folding tab extends beyond the boundaries of the stock sheet. In a particular embodiment, with the folding tab in the first position, the boundaries of the stock sheet are such that the stock sheet may be fed through a standard printing apparatus of the type that prints upon stock sheets having substantially straight edges.

This invention also provides a method for providing a divider with an indicia-bearing tab. A stock sheet is provided having a binder edge and a plurality of free edges. A folding tab is formed in the stock sheet proximate one of the plurality of free edges, and is defined, in part, by a fold line, such that the folding tab folds along the fold line from a first position, wherein the folding tab lies within the boundaries of the stock sheet as defined by the binder edge and plurality of free edges, to a tab position, wherein a portion of the folding tab extends beyond the boundaries of the stock sheet. The folding tab is printed on, and is folded to the tab position along the fold line. The folding tab may be printed upon by hand, with the folding tab in either its first position or its tab position, or the folding tab may be printed upon by feeding the stock sheet through a printing apparatus with the folding tab in its first position.

To aid in the production of dividers in accordance with this invention, a device is also provided for forming folding tabs in a stock sheet. This device includes a backing plate and a stamp head. The stamp head includes a score blade and a cutting blade. The score blade has terminal ends, and the cutting blade extends between the terminal ends of the score blade. The stamp head is offset from the backing plate and is movable to bring said score blade and said cutting blade into contact with said backing plate. The cutting blade may cut or perforate or otherwise provide for the separation of stock sheet material, and, in use, a stock sheet is placed between the cutting blade and the backing plate so that the cutting blade may be brought into contact with the backing plate to form a folding tab in the stock sheet defined by the score blade and cutting blade.

### BRIEF DESCRIPTION OF DRAWINGS

For a complete understanding of the objects, techniques and structure of the invention, reference should be made to the following detailed description and accompanying drawings wherein:

FIG. 1 is a top plan view of an embodiment of a divider in accordance with this invention;

FIG. 2 is a top plan view of the embodiment of FIG. 1, shown with its folding tab folded to provide a tab extending from one of the edges of the stock sheet;

FIG. 3 is a top plan view of an alternative embodiment a divider in accordance with this invention;

FIG. 4 is a side elevation view of a tab forming device;

FIG. 5 is a view of the face of a stamp head of a tab forming device, taken along the line 5-5 of FIG. 4; and

FIG. 6 is a perspective view of a textbook having dividers in accordance with this invention placed, by way of example, at the beginning of chapters.

### PREFERRED EMBODIMENT OF THE INVENTION

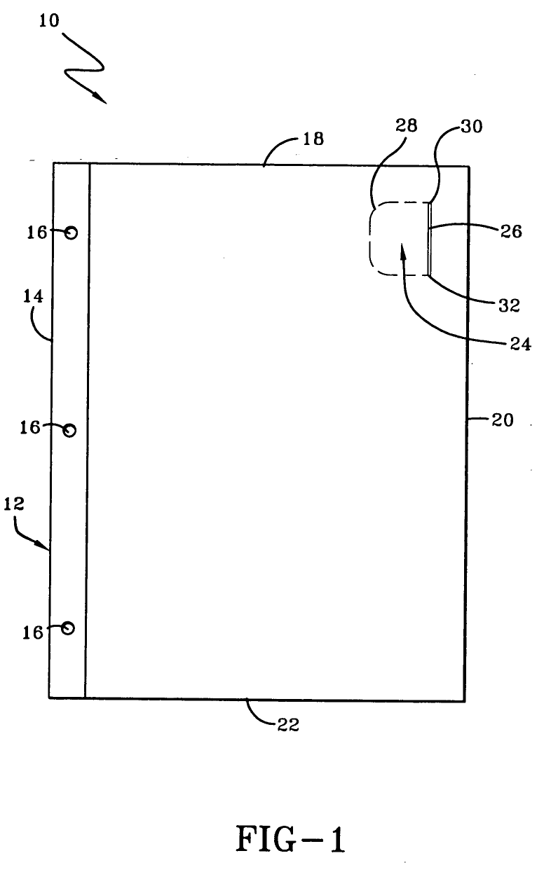

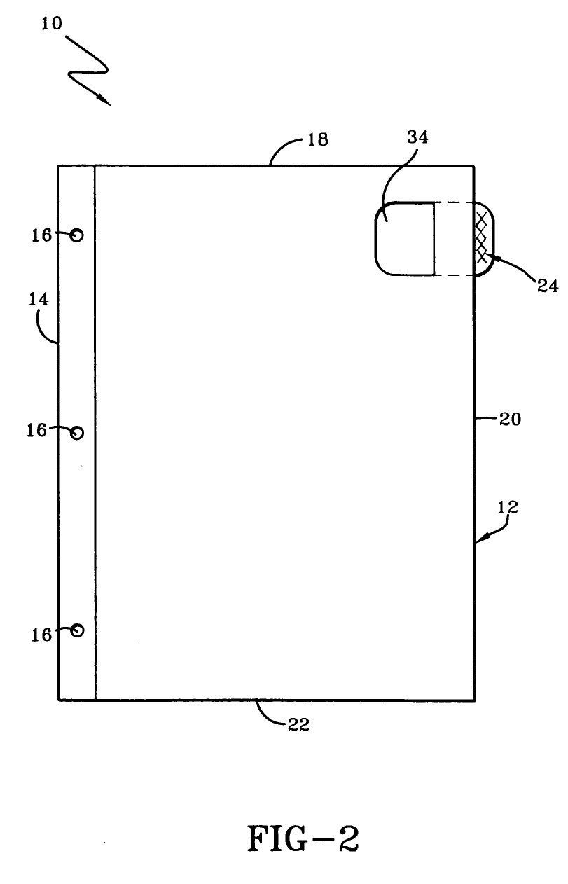

With reference to FIGS. 1 and 2, it can be seen that a divider in accordance with this invention is shown and designated generally by the numeral 10. Divider 10 is a stock sheet 12, preferably of printable material, although the present invention is not limited thereto. The boundaries of stock sheet 12 are defined by binder edge 14 and by a plurality of free edges 18, 20, and 22 (the top edge, right edge, and bottom edge, of FIG. 1). Stock sheet 12 includes binder edge 14, which, in the embodiment shown, includes holes 16 in close proximity for placing divider 10 in a common three-ring notebook. Although three-ring notebooks are mentioned, for different types of notebooks, stock sheet 10 may take different forms, and binder edge 12 may be located at different positions along the edges of stock sheet 12. For instance, for notebooks in which the pages are inserted therein or flipped along a horizontal line, binder edge 14 and a suitable number of holes 16 may be provided at the top edge 18 of stock sheet 12.

In the embodiment shown, folding tab 24 is provided proximate free edge 20, which is the right edge of the stock sheet 12 shown in FIG. 1. From the description that follows, it should be appreciated that folding tab 24 could alternatively be placed proximate top free edge 18 or bottom edge 22. Folding tab 24 is defined by fold line 26 and tab border 28. Fold line 26 is defined by terminal points 30, 32 thereof, and tab border 28 extends between terminal points 30, 32. In particularly preferred embodiments, fold line 26 is further defined by a score line pressed into stock sheet 12 between terminal points 30, 32, because such a score line facilitates folding tab 24 to a tab position, as will be described. Preferably, tab border 28 is a perforation extending between terminal points 30, 32 of fold line 26 such that folding tab 24 is releasably secured in the position shown in FIG. 1 by the perforations.

In the position shown in FIG. 1, a simple word processing program or other software program associated with a printer or photocopying machine or other printing apparatus may be programmed to print on folding tab 24. Because folding tab 24 lies within the boundaries of stock sheet 12, stock sheet 12 may be fed through such printing apparatus in a manner identical to standard sheets of paper. After the desired indicia is printed onto folding tab 24, folding tab 24 may be folded along fold line 26 to the position shown in FIG. 2, wherein the indicia (designated as “XXXX”) is visible on that portion of folding tab 24 that extends beyond free edge 20. A hole 34 is left within the boundaries of stock sheet 12. It should be appreciated that folding tab 24 might be provided proximate free edge 18 or free edge 22 to fold and extend beyond those respective edges.

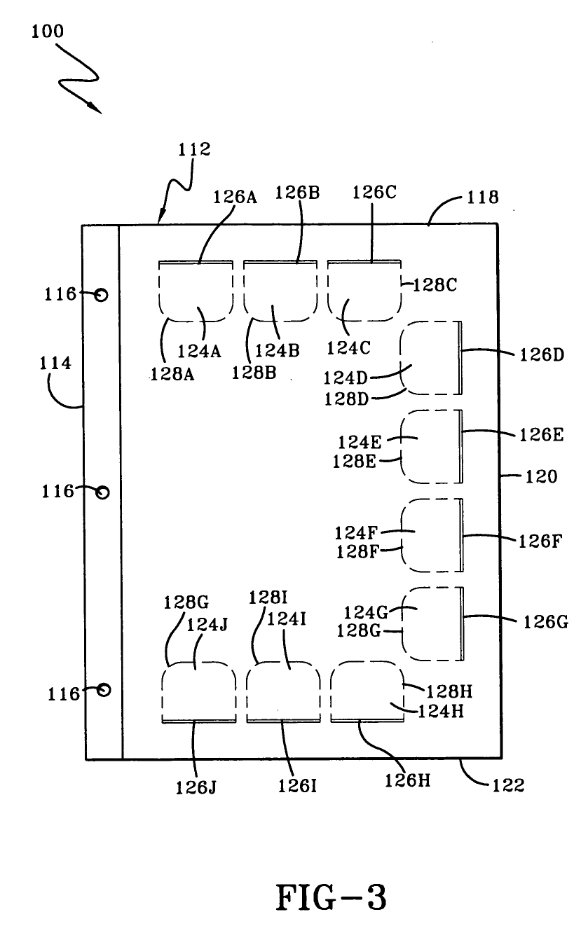

Referring now to FIG. 3, it can be seen that a plurality of folding tabs may be provided in a stock sheet. In FIG. 3 an alternative divider 100 is shown, and like parts have received like numerals increased by 100. Thus divider 100 is formed of stock sheet 112, having binder edge 114, holes 116, and free edges 118, 120, and 122. A plurality of folding tabs are formed therein, and designated by the numerals 124A, 124B, 124C, and so on through to 124J (collectively referred to herein as folding tab 124). Each folding tab 124 includes its own respective fold line 126 A-J (collectively 126) and tab border 128 A-J (collectively 128). This embodiment, as with the embodiment of FIGS. 1 and 2, preferably includes scored fold lines 126 and perforated tab borders 128. Additionally, it is preferable that stock sheet 112 be made of a material that is printable. Additionally, any number of folding tabs 124 may be provided proximate any free edge 118, 120, 122, and all such folding tabs need not be provided along the same edge. With this particular embodiment, multiple dividers 100 may be provided, allowing the user to decide which tab position is to be printed upon and folded out to the tab position.

As mentioned, it is preferable that dividers in accordance with this invention be printable. However, this invention is not limited thereto or thereby, as other beneficial aspects of this invention exist. Notably, when employing a multiple number of dividers 10 or 100 in a notebook, materials within the notebook may be identified in different ways, at different times. For instance, if a notebook contained materials on topics A, B, C, D, and E, each topic A-E could be separated from the remainder by appropriately positioned divider 10 or 100. Advantageously, if the notebook was being taken to a meeting in which only topics A, C and D were to be discussed, the folding tabs of the dividers for topics B and E could be folded back to their first position in which they do not extend beyond the boundaries of the stock sheet. Thereafter, if a subsequent meeting is to cover topics A, B and E, the folding tabs on the dividers for topics C and D could be folded to their first positions, while the folding tabs for the dividers of topics A, B and E could be selectively folded to their tab positions.

Any of the forgoing divider embodiments could advantageously be provided as bound to the binding of a book at strategic places. For example, in a school text book, the dividers could be placed at each chapter and at each appendix and the index, and a student could selectively fold outwardly those tabs that identify the particular chapters under study at any given time. In this way, the student could quickly find the correct chapter(s) for a particular day's lesson. This concept is shown in FIG. 6, with a text book 300 having chapter dividers identified by both the numeral 10 and the numeral 100 to indicate that any of the above disclosed dividers 10 or 100 may be employed. Indeed, as the invention is not limited to the specific embodiments shown, any divider in accordance with this invention could be so employed.

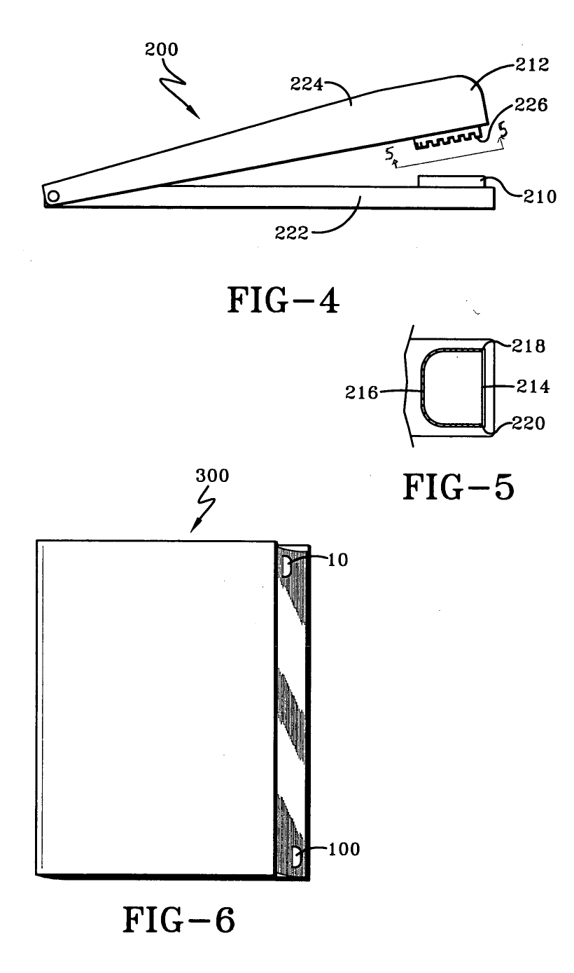

Referring now to FIGS. 4 and 5, a stamping device for providing folding tabs in a stock sheet is shown and designated by the numeral 200. Stamping device 200 includes backing plate 210 and stamp head 212. Stamp head 212 includes score blade 214 and cutting blade 216. Score blade 214 is provided to create fold line 26, and, as such, includes terminal ends 218, 220. In the embodiment shown, backing plate 210 and stamp head 212 are provided on their own respective lever arms 222, 224, which pivot relative to one another to bring stamp head 212 into contact with backing plate 210. Thus, by placing a stock sheet between backing plate 210 and stamp head 212, a folding tab may be formed in the stock sheet when stamp head 212 (particularly score blade 214 and cutting blade 216) is brought into contact with backing plate 210. Score blade 214 is designated as a “score blade,” but does not have to provide a score line inasmuch as the stock sheet, once punched, will have a tab that folds between the end points created by terminal ends 218, 220. Indeed, score blade 214 need not be provided although it is preferred. Cutting blade 216 may provide perforations, as indicated at teeth 226, or may smoothly cut or otherwise provide a means for separating a tab from the stock sheet between terminal ends 218, 220. Cutting blade 216 extends between terminal ends 218, 220. With stamping device 200, stock sheets could be printed upon, as described above, before forming folding tabs in the stock sheet.

While in accordance with the patent statues only the preferred embodiments of the present invention have been described in detail, the present invention is not to be limited thereto or thereby. Rather, the scope of the invention shall include all modifications and variations that fall within the scope of the attached claims.

What is claimed is:

1. A printable divider comprising:
a stock sheet having a binder edge and a plurality of free edges; and
a folding tab formed within said stock sheet proximate one of said plurality of free edges and folding along a fold line from a first position, wherein said folding tab lies within the boundaries of said stock sheet as defined by said binder edge and plurality of free edges, to a tab position, wherein a portion of said folding tab extends beyond said boundaries of said stock sheet.

2. The printable divider of claim 1, wherein said folding tab is defined by said fold line and by perforations, said folding tab being secured in said first position by said perforations.

3. The printable divider of claim 1, wherein, with said folding tab in said first position, said boundaries of said stock sheet are such that said stock sheet may be fed through a standard printing apparatus able to handle stock sheets with substantially straight edges.

4. The printable divider of claim 1, comprising a plurality of said folding tabs.

5. A method for providing a divider with an indicia-bearing tab comprising the steps of:
providing a stock sheet having a binder edge and a plurality of free edges;
forming a folding tab in said stock sheet proximate one of said plurality of free edges, wherein the folding tab is defined in part by a fold fine such that the folding tab folds along the fold line from a first position, wherein said folding tab lies within the boundaries of said stock sheet as defined by the binder edge and plurality of free edges, to a tab position, wherein a portion of the folding tab extends beyond the boundaries of the stock sheet;
printing on the folding tab; and
folding the folding tab along the fold line to the tab position.

6. The method of claim 5, wherein said step of printing on the folding tab includes printing on the folding tab by hand, with the folding tab in either its first position or its tab position.

7. The method of claim 5, wherein said step of printing on the folding tab includes feeding the stock sheet through a printing apparatus with the folding tab is its first position.

8. The method of claim 5, wherein, in said step of forming a folding tab, the fold line is formed by scoring the stock sheet.

9. The method of claim 8, wherein the folding tab is also defined by a tab border extending between terminal points of the fold line, the tab border being formed in said step of forming a folding tab.

10. The method of claim 9, wherein the border defining the folding tab is formed from perforations in the stock sheet.

11. The method of claim 9, wherein said step of forming a folding tab includes punching the fold line and the tab border with a manual tab punching device.

12. The method of claim 5, wherein, in said step of forming a folding tab, multiple folding tabs are formed in the stock sheet proximate selected ones of the plurality of free edges, with each folding tab defined in part by a fold line such that each folding tab folds along its associated fold line from a first position, wherein the folding tab lies within the boundaries of said stock sheet as defined by the binder edge and plurality of free edges, to a tab position wherein a portion of the folding tab extends beyond the boundaries of said stock sheet to form a tab.

13. A device for providing folding tabs in a stock sheet comprising:
a backing plate; and
a stamp head including a cutting blade extending between terminal ends of said cutting blade, said stamp head being offset from said backing plate and movable to bring said cutting blade into contact with said backing plate, wherein said cutting blade forms a tab border in a stock sheet placed between said cutting blade and said backing plate when said cutting blade is brought into contact with said backing plate.

14. The device of claim 13, wherein said cutting blade is perforated and forms a perforated tab border on a stock sheet placed between said cutting blade and said backing plate when said cutting blade is brought into contact with said backing plate.

15. The device of claim 13, further comprising a score blade extending between said terminal ends of said cutting blade.

16. A book comprising:
a binding;
a plurality of pages bound to said binding and having boundaries defined by edges of said pages; and
at least one divider bound to said binding to identify a specific portion of the book, said at least one divider comprising:
a stock sheet having a binder edge and a plurality of free edges; and
a folding tab formed within said stock sheet proximate one of said plurality of free edges and folding along a fold line from a first position, wherein said folding tab lies within the boundaries of said stock sheet as defined by said binder edge and plurality of free edges, to a tab position, wherein a portion of said folding tab extends beyond said boundaries of said stock sheet and beyond the boundaries of said plurality of pages.
